(19) United States
(12) Patent Application Publication
(10) Pub. No.: US 2019/0026460 A1
(43) Pub. Date: Jan. 24, 2019

(54) DYNAMIC CREATION OF ISOLATED SCRUBBING ENVIRONMENTS

(71) Applicant: Cisco Technology, Inc., San Jose, CA (US)

(72) Inventors: Michael J. Robertson, Apex, NC (US); Magnus Mortensen, Cary, NC (US); Jay K. Johnston, Raleigh, NC (US); David C. White, JR., St. Petersburg, FL (US)

(21) Appl. No.: 15/654,169

(22) Filed: Jul. 19, 2017

(51) Int. Cl. G06F 21/53; H04L 29/06

(52) U.S. Cl. CPC G06F 21/53; G06F 2009/45587; H04L 63/20; H04L 63/1425

(57) ABSTRACT

An application security monitors data traffic from computing devices to a remote application in a first computing environment, such as a production service chain. The application security monitor detects an anomaly in the data traffic from a computing device. Based on the anomaly, the remote application is substantially reproduced in a second computing environment, such as a scrubbing environment. The application security monitor redirects the anomalous data to the remote application in the second computing environment. The application security monitor determines whether the data traffic from the first computing device corresponds to malicious activity or legitimate activity by the computing device. Responsive to a determination that the data traffic from the first computing device corresponds to legitimate activity, the application security monitor applies to the first computing environment any changes in the second computing environment caused by the redirected traffic from the computing device.

### TECHNICAL FIELD

The present disclosure relates to securely providing access to remote applications.

### BACKGROUND

Modern application security solutions include a combination of network layer filtering (e.g., firewalls, load balancing, intrusion detection/prevention systems, etc.) and application layer filtering (e.g., web application firewalls, security policy frameworks, secure application design, etc.). These solutions involve detailed, statically defined security policies to determine whether a particular access to the application is maliciously intended. Additionally, the requirements of the security policies may change over time. Security solutions often result in “all or nothing” protection, which results in traffic either being allowed (and processed) or dropped completely.

### BRIEF DESCRIPTION OF THE DRAWINGS

FIG. 1 is a simplified block diagram of a system to provide application security to a remotely provided application, according to an example embodiment.

FIG. 2A is a simplified block diagram showing the application security system detecting anomalous data traffic from a computing device, according to an example embodiment.

FIG. 2B is a simplified block diagram showing the application security system redirecting suspicious traffic to a second computing environment, according to an example embodiment.

FIG. 2C is a simplified block diagram showing the application security system updating the original computing environment after the suspicious traffic is determined to be legitimate, according to an example embodiment.

FIG. 3 is a flow chart illustrating the operations performed in the application security system to process anomalous data traffic, according to an example embodiment.

FIG. 4 is a flow chart illustrating the operations performed by an application security monitor in processing anomalous data traffic in a second computing environment while determining the legitimacy of the data traffic, according to an example embodiment.

FIG. 5 is a flow chart illustrating the operations performed by a second computing environment in processing suspicious data traffic redirected from a first computing environment while determining the legitimacy of the suspicious data traffic, according to an example embodiment.

FIG. 6 is a simplified block diagram of a device that may be configured to perform methods presented herein, according to an example embodiment.

### DESCRIPTION OF EXAMPLE EMBODIMENTS

### Overview

In one embodiment, a computer-implemented method is provided for directing anomalous data from a first computing environment to a second computing environment until it is determined to be not malicious. The method includes monitoring data traffic from a plurality of computing devices to at least one remote application in the first computing environment. An anomaly is detected in the data traffic from a first computing device among the plurality of computing devices. Based on the detected anomaly, the at least one remote application is substantially reproduced in the second computing environment. The data traffic from the first computing device is redirected to the at least one remote application in the second computing environment. The method further includes determining whether the data traffic from the first computing device corresponds to malicious activity or legitimate activity by the first computing device. Responsive to a determination that the data traffic from the first computing device corresponds to legitimate activity, the method includes applying to the first computing environment any changes in the second computing environment caused by the redirected traffic from the first computing device.

### DETAILED DESCRIPTION

The concepts of traffic sinkholes and data scrubbing are used in network security solutions, but these solutions typically operate in the network and transport layers. For instance, remotely triggered black hole filtering uses routing protocols to “null route” malicious traffic based on an Internet Protocol (IP) address. Solutions for Distributed Denial of Service (DDoS) attacks may redirect traffic to a scrubbing site where connections may be offloaded. These connections are proxied and temporarily reset at the Transport Control Protocol (TCP) and/or Transport Layer Security (TLS) layers, assuming that only legitimate clients will attempt to reconnect.

Additionally, application aware protections systems, such as intrusion prevention systems (IPS), may selectively filter connections and packets based on criteria such as static data strings or pre-defined application behaviors. However, these systems offer “all or nothing” protection in which a connection is either allowed to pass through to the protected endpoint or it is denied and dropped.

The concept of a “honeypot” trap allows intentionally exposed, but safely isolated, targets to be attacked for the purposes of security monitoring and keeping malicious attackers distracted. However, this solution is provided completely out-of-band from a production application/environment and offers no promise of protection for actual targets in production environments.

The techniques presented herein provide an application security solution in which a scrubbing environment is dynamically extended to the production application layer, and may provide an alternative to statically defined deny/drop security policies. For instance, if the system detects a particular user generating an unusually high number of 4XX/5XX errors (i.e., signs of an attempt to penetrate or break the application), the potential attacker may be deflected to the scrubbing container (e.g., via HyperText Transfer Protocol (HTTP) redirects, proxy/load balancer endpoint changes, route injections, etc.). After being redirected, the attacker may continue their attempts on an isolated system with realistic application behaviors while the production endpoints are left to process known legitimate traffic.

The application security solution presented herein uses safely isolated copies of production applications running in a separate set of “scrubbing” containers, to which suspicious traffic may be dynamically redirected for further processing. In one example, service chains may quickly redirect traffic in (and back out) of the scrubbing environment. The scrubbing environment may be a complete copy of the production environment, but without any sensitive data.

Since an attacker's traffic is redirected and terminated in the scrubbing environment, the attacker does not gain access to the production data, even if they gain full control inside the scrubbing environment. The scrubbing containers would typically continue to process the attacker's transactions in isolation to avoid tipping them off to the presence of a security solution. This keeps the attacker distracted in an easily monitored and contained environment without risk to the production infrastructure. Additionally, the scrubbing environment may modify runtime characteristics to act as a “tar pit” for the suspicious traffic. For instance, the scrubbing environment may run with 1/10^{th} the normal processing speed to slow down an attack, enabling better forensics systems to be engaged to trace the source of the attack or otherwise engage the attack.

Network traffic processed by the application security system described herein may be defined according to characteristics of the traffic. Malicious traffic refers to traffic that has been positively determined (e.g., through analysis of characteristics of the traffic) to be a threat, which should not be allowed access to the production environment and/or sensitive data. Legitimate traffic refers to traffic that has been positively determined (e.g., through analysis of characteristics of the traffic) to not be a threat, and can be processed with the production environment including any sensitive data. Suspicious/anomalous traffic refers to traffic that has at least one indication of potentially malicious behavior, but has not been positively determined either to be malicious traffic or legitimate traffic.

The endpoints that run the application in the production environment need not waste any resources processing traffic from potentially illegitimate clients, since any suspicious traffic is completely redirected away from the production service chain/nodes and into the sinkhole/scrubbing containers. If the suspicious traffic is determined to be legitimate, it can be passed pack to the production application endpoint. If the suspicious traffic is deemed to be malicious, it may be processed safely in the isolated environment without exposing production data or production systems. The continued processing of the malicious traffic may give the attacker a false sense of functionality while additional countermeasures are directed at the malicious traffic. Alternatively, the malicious traffic may be simply dropped.

Two components may be added to a typical web application service chain in order to implement some of the features described herein. An Application Security Monitor (ASM) may be implemented as a container that is inserted into the service chain between end users and the application front end (e.g., an HTTP server). The ASM may be responsible for running the analytics that determine whether a particular user's behavior is suspicious. The ASM may also be responsible for orchestrating the creation (and deletion) of the scrubbing environments and intelligently redirecting a user's traffic to the appropriate scrubbing environment. A Database Transaction Recorder (DTR) may be implemented as a container in the scrubbing environment that is inserted in the service chain between the application front end (e.g., HTTP server) and the back end (e.g., a database server). The DTR may be responsible for recording a transaction log of any queries that a user makes within the scrubbing environment. If a user's session is determined to be legitimate and safe, the DTR may replay the recorded transactions into the production database so that the user's session data is maintained.

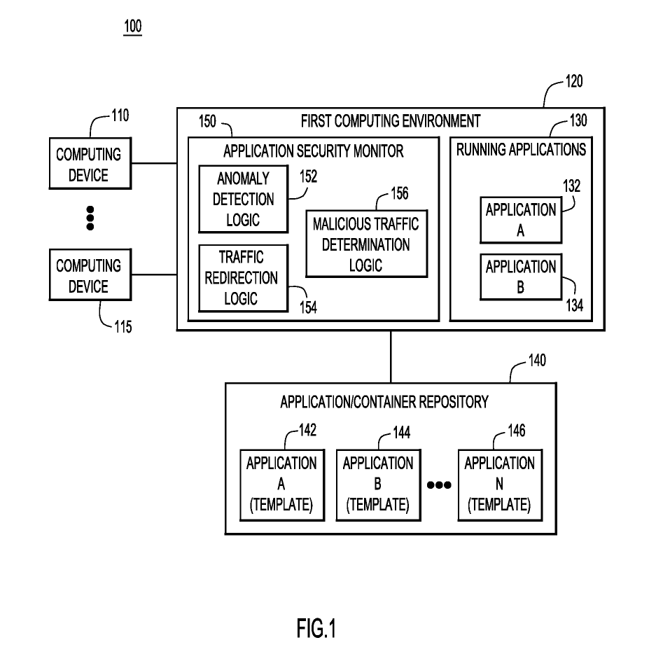

Referring now to FIG. 1, a simplified block diagram of an application security system 100 is shown. A plurality of computing devices, including computing device 110 and computing device 115, are connected to a first computing environment 120, which provides services to the computing devices. The first computing device 120 may be implemented on one or more physical computers or virtual machines. The first computing environment 120 includes running applications 130, including application 132 (i.e., application A) and application 134 (i.e., application B). The applications 132 and 134 may be provided in the first computing environment 120 as containers that virtualize the running applications 130.

The first computing environment 120 is connected to an application/container repository 140. The repository 140 includes a plurality of application templates 142, 144, and 146 which can be used to instantiate running applications in computing environments (e.g., the first computing environment 120). In this example, the applications 132 and 134 were instantiated from the application templates 142 and 144, respectively.

The first computing environment 120 also includes an application security monitor 150 that coordinates the application security system 100 for the first computing environment 120. The application security monitor 150 includes anomaly detection logic 152, traffic redirection logic 154 and malicious traffic determination logic 156. The anomaly detection logic 152 detects whether the network traffic from a computing device (e.g., computing device 110) to one or more of the running applications 130 (e.g., application 132) fulfills at least one preliminary criterion for considering the traffic to be suspicious and potentially malicious. The traffic redirection logic 154 redirects any suspicious network traffic (e.g., traffic that the anomaly detection logic 152 determines is suspicious) away from the first computing environment 120. The malicious traffic determination logic 156 makes a final determination as to whether the suspicious network traffic is malicious or not.

In one example, network traffic from a computing device 110 may be associated with a particular user of the computing device 110. Network traffic from that particular user may be determined to be suspicious even if it comes from a different computing device, such as computing device 115.

In another example, the application security monitor 150 may be implemented as one of the running applications 130 that is generated from a template in the repository 140. The application security monitor 150 may be a container running in a production computing environment to protect the other applications 130 that are running in the first computing environment.

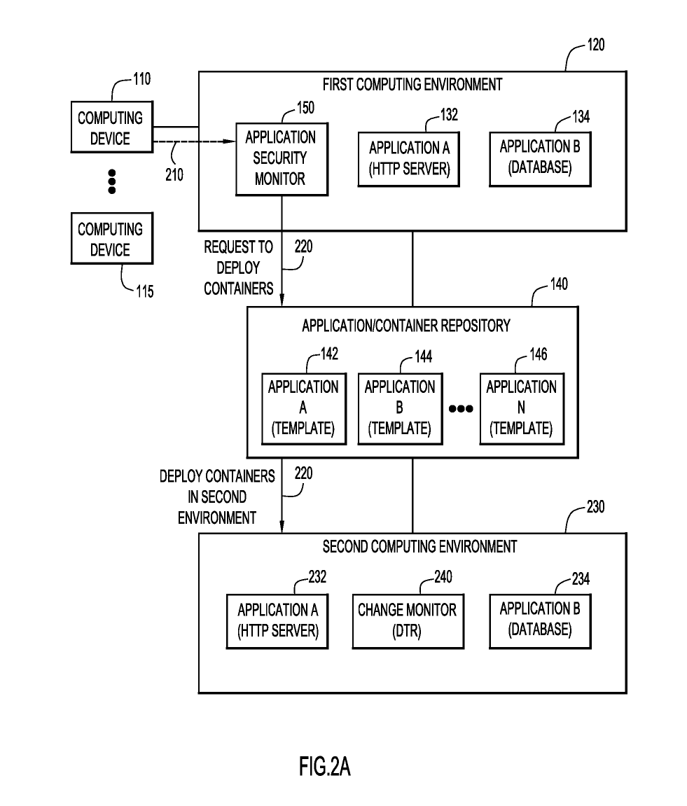

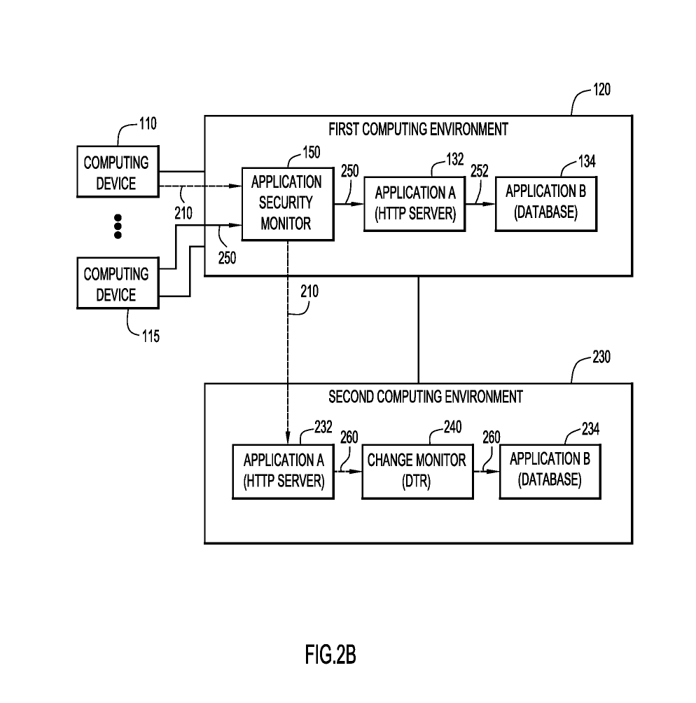

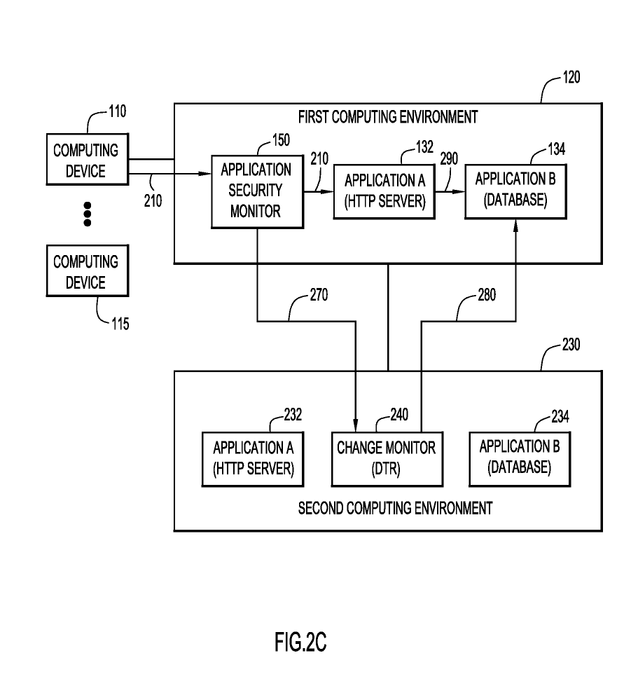

Referring now to FIG. 2A, a simplified block diagram illustrates the steps of initiating a scrubbing environment in response to anomalous network traffic. The computing device 110 sends network traffic 210 to a front end application (e.g., application 132) in the first computing environment. If the application security monitor 150 determines that network traffic 210 from the computing device 110 is potentially malicious, the application security monitor 150 sends a request 220 to deploy containers corresponding to the applications 132 and 134 in a second computing environment 230. In one example, the second computing environment 230 runs on a separate computing platform (e.g., a different physical or virtual machine) than the first computing environment 120.

The second computing environment 230 receives the application templates 142 and 144 corresponding to the applications 132 and 134 that are running in the first computing environment 120 and instantiates corresponding applications 232 and 234 in the second computing environment 230. The application security monitor 150 also causes a change monitor 240 to be instantiated in the second computing environment 230. The change monitor 240 is configured to detect and optionally record at least some of the changes to the second computing environment 230 as the suspicious network traffic 210 is processed by the applications 232 and 234.

In one example, the first computing environment 120 may be a production environment for a remote application (e.g., a banking application). A simplified version of the remote application is represented by application 132 serving as a front end HTTP server to provide the user interface, and application 134 serving as a back end database server (e.g., to store user account data). Under normal operating conditions, when a user of the computing device 110 tries to access his bank account, the traffic from the computing device 110 will flow as expected through the production chain (e.g., to the front end HTTP server 132 and the back end database server 134).

The application security monitor 150 is deployed between the computing device 110 and the HTTP server 132 to transparently inspect all requests at the application layer. In other examples, the application security monitor 150 may be deployed in different locations. The application security monitor 150 may be configured by an application administrator with various analytics (e.g., anomaly detection logic 152) that define rules for how a normal user should behave when interacting with their bank accounts. The anomaly detection logic 152 may include various techniques to detect behavior, such as classic intrusion prevention system signatures or machine learning algorithms. For instance, the application security monitor 150 may compare all account login attempts against the user's source Internet Protocol (IP) address. The anomaly detection logic 152 may define a rule that, in normal operation, a single source IP address should not attempt to authenticate with more than a predetermined number of user accounts (e.g., three user accounts) within a specific amount of time (e.g., thirty minutes). Breaking this rule may indicate a brute force login attack.

Additionally, the application security monitor 150 may inspect all traffic and identify any data that matches the pattern of an account number, such as nine digits separated by a dash of the fifth digit (i.e., 12345-6789). The anomaly detection logic 152 may define a rule that, in normal operation, a user should not attempt to send a request containing any account number other than his/her own. Breaking this rule may indicate an attacker is attempting to expose sensitive account details of other users. For instance, if the user using the computing device 110 sends a request 210 to access another user's account number, the application security monitor 150 flags all traffic 210 from the computing device 110 to be suspicious, and begins deploying a scrubbing environment to which the traffic 210 can be redirected. Containers are easily and quickly deployed, enabling these isolated environments to be built and torn down on the fly. The isolated, scrubbing environment (e.g., second computing environment 230) may be specific to the network traffic 210 from the computing device 110. Additional scrubbing environments may be generated for each user generating suspicious traffic.

Further, the application security monitor 150 may be responsible for some or all of the analytics that are performed for monitoring the traffic to a production environment and scrutinizing anomalous traffic that is being redirected to the scrubbing environment. The application security monitor 150 may be responsible for dynamically redirecting traffic into and/or out of a scrubbing environment based on application layer information, which determines if the traffic is potentially malicious. The application security monitor 150 may also be responsible for deploying copies of the scrubbing environments on demand, based on the behavior of users. The application security monitor 150 may deploy a unique scrubbing environment for each scrutinized user. This may include provisioning separate back end services to eliminate exposure of production components that may contain sensitive data. For instance, the application security monitor 150 may deploy a database server in the scrubbing environment with fake and/or sanitized data in a schema identical to that of the production database.

In another example, the second computing environment 230 may run on a virtual machine designated as a sinkhole virtual machine. Additional computing environments may be generated on the sinkhole virtual machine to act as scrubbing/sinkhole environments for network traffic from other computing devices and/or users. The sinkhole virtual machine may be provided by the same physical computing resources that provides a separate virtual machine for the first computing environment 120. Alternatively, the second computing environment 230 may run on a completely separate physical server than the first computing environment 120. In yet another example, the second computing environment 230 and the first computing environment 120 may be run on the same virtual machine. If both computing environments are provided on the same virtual machine, the second computing environment 230 is isolated from the first computing environment 120 through the instantiation of separate containers for the applications in each computing environment.

In a further example, the application security monitor 150 may orchestrate the deployment of the second computing environment 230 that serves as the scrubbing environment. For instance, the application security monitor 150 may deploy a cloned version of the production HTTP server 132 into the scrubbing environment 230. Since any sensitive data is stored in the back end database 134, and not on the web server 132, the cloned HTTP server 232 may be an exact replica of the production HTTP server 132 (e.g., same software version, same application code, etc.). The application security monitor 150 may reuse the container template 142 that was used to generate the production HTTP server 132 to generate the cloned HTTP server 232 quickly.

The application security monitor 150 may deploy a container for a scrubbing database 234 to mimic the production database 134. The scrubbing database 234 for the scrubbing environment 230 may run the same software versions with the same schema as the production database 134. However, the scrubbing database 234 may be pre-populated with fake and/or sanitized data to prevent data exposure. The application security monitor 150 has intercepted the user identity and account number of the computing device 110 from the suspicious traffic 210, and may accurately transfer any information from this user identity and account number from the production database 134 to the scrubbing database 234. The accurate information for the user/account that generated the suspicious traffic 210 may give the user the false impression that all of the data in the scrubbing database 234 is accurate. The back end services in the scrubbing environment 230 are cloned to mimic the production services (e.g., back end application 134), but with at least some non-production data.

The application security monitor 150 may deploy a Database Transaction Recorder (DTR) as the change monitor 240 and position the DTR 240 inline between the cloned HTTP server 232 and the scrubbing database 234. Though the production HTTP server 132 may be configured to communicate directly with the production database 134, the cloned HTTP server 232 may be linked to the DTR 240 as an intermediary for the purposes of recording and auditing any database transactions that occur in the scrubbing environment 230. In one example, the DTR 240 may monitor all queries to the scrubbing database 234 in an effort to create a transaction delta of the user's session. If the analytics in the application security monitor 150 determine that a users' behavior is within normal parameters, the DTR 240 may execute the transaction delta on the production database 134 so that the user's session maintains its state in the production environment 120. The transaction delta may be applied to the production database 134 seamlessly, masking the fact that the user was ever being scrutinized by the application security system.

Referring now to FIG. 2B, a simplified block diagram is shown that illustrates the steps of redirecting anomalous data traffic to a second computing environment while processing legitimate traffic in a first computing environment. In addition to receiving suspicious traffic 210 from the computing device 110, as described with respect to FIG. 2A, the application security monitor 150 receives traffic 250 from the computing device 115. Since the application security monitor 150 does not detect any anomalous behavior in the traffic 250, the application security monitor 150 forwards the traffic 250 to the front end application 132 (e.g., an HTTP server) in the first computing environment 120. The application 132 processes the traffic 250 and sends traffic 252 to the back end application 134 in the first computing environment 120.

Since the application security monitor 150 detects anomalous behavior in the suspicious traffic 210, the application security monitor 150 redirects the traffic 210 to the front end application 232 (e.g., an HTTP server) in the second computing environment 230 that corresponds to the front end application 132 in the first computing environment 120. The application 232 processes the traffic 210 and sends the traffic 260 to the change monitor 240, which records any changes that the traffic 260 will cause, to the second computing environment 230. The change monitor 240 forwards the traffic 260 to the back end application 234 in the second computing environment 230 that corresponds to the back end application 134 in the first computing environment 120.

In other words, once the second computing environment 230 (e.g., the scrubbing environment) is ready, the application security monitor 150 starts redirecting any of the traffic from the computing device 110 to the scrubbing environment's application 232. Meanwhile, traffic from other devices/users that are not under scrutiny (i.e., computing device 115) is free to continue being processed in the first computing environment 120 without any impact from the suspicious traffic 210.

In one example, the second computing environment 230 (e.g., the scrubbing environment) may be differentiated from the first computing environment 120 (e.g., the production environment) in that the front end application 232 (e.g., the HTTP server) may be run with less computing resources than the front end application 132. The slowdown of the front end application 232 limits the rate of suspicious traffic and acts as a tar pit to slow a potential attack from the computing device 110. Additionally, the slowdown may serve to discourage further probing by the computing device 110 and facilitate the analysis of the suspicious traffic 210.

In another example, the HTTP server 232 in the second computing environment 230 is completely separate from the back end application 134 (e.g., the production database) and has no access to the sensitive data in the production database 134. Even if the suspicious traffic 210 is an attack from the computing device 110 that succeeds in breaching another user's account, any data available to the attacker using the computing device 110 will be fake and/or sanitized data from the back end application 234 in the scrubbing environment 230. No actual data from the production database 134 is exposed to the computing device 110 other than the data that the computing device 110 would be authorized to access.

In a further example, the scrubbing environment 230 may be deployed specifically to handle suspicious traffic from the computing device 110. The separate computing environment ensures that attacks from the computing device 110 will not compromise the experience of users at other computing devices (e.g., computing device 115) while they access their own data. Additionally, the suspicious traffic 210 from the computing device 110 may be easily isolated in the scrubbing environment 230 from the multitude of legitimate traffic being handled in the production environment 120, facilitating forensic analysis of the suspicious traffic 210.

In still another example, while the suspicious traffic 210 is under scrutiny, the application security monitor 150 may continue to inspect the traffic 210 to detect any additional suspicious behavior. Any requests that are determined to be safe (e.g., not malicious attacks) may be recorded by the change monitor 240 (e.g., a Database Transaction Recorder) and added to a transaction log for the computing device 110. For instance, if the user of the computing device 110 requests a withdrawal from a bank account associated with the user, the balance decrease is recorded in the transaction log.

Referring now to FIG. 2C, a simplified block diagram illustrates the steps of updating the first computing environment after the suspicious traffic is determined to be legitimate. On further inspection of the suspicious traffic 210 from the computing device 110, the application security monitor 150 may determine that the traffic 210 is now safe (i.e., any subsequent requests are legitimate), and/or that the suspicious traffic 210 was flagged as a false positive. If the application security monitor 150 determines that the suspicious traffic 210 is no longer suspicious, the application security monitor 150 sends a message 270 to the change monitor 240 in the second computing environment 230 to update the first computing environment 120. The change monitor 240 gathers any changes made to the second computing environment 230 as a result of the traffic 210 and sends the changes 280 to the first computing environment 120.

After the changes 280 are incorporated into the first computing environment 120, the application security monitor 150 redirects the traffic 210 back to the front end application 132 in the first computing environment 120. The front end application 132 processes the traffic 210 that has been determined to be legitimate, and sends the processed traffic 290 to the back end application 134. Additionally, once the changes 280 have been incorporated back into the first computing environment, and any subsequent traffic 210 is redirected back to the first computing environment 120, the application security monitor 150 may tear down the second computing environment 230.

In one example, the change monitor 240 is a database transaction recorder and the changes to the second computing environment 230 are gathered in a transaction log 280 that is sent to the back end database 134 of the first computing environment 120. The transactions in the transaction log 280 may be “replayed” into the back end database of the first computing environment 120 to maintain the content of the session with the computing device 110. This process may occur seamlessly, such that the user of the computing device 110 is completely unaware that traffic from the computing device 110 was ever under scrutiny. Once the application security monitor 150 determines that the traffic 210 from the computing device 110 is legitimate, any changes (e.g., a withdrawal from a bank account) made in the second computing environment 230 are accurately reflected in the first computing environment 120.

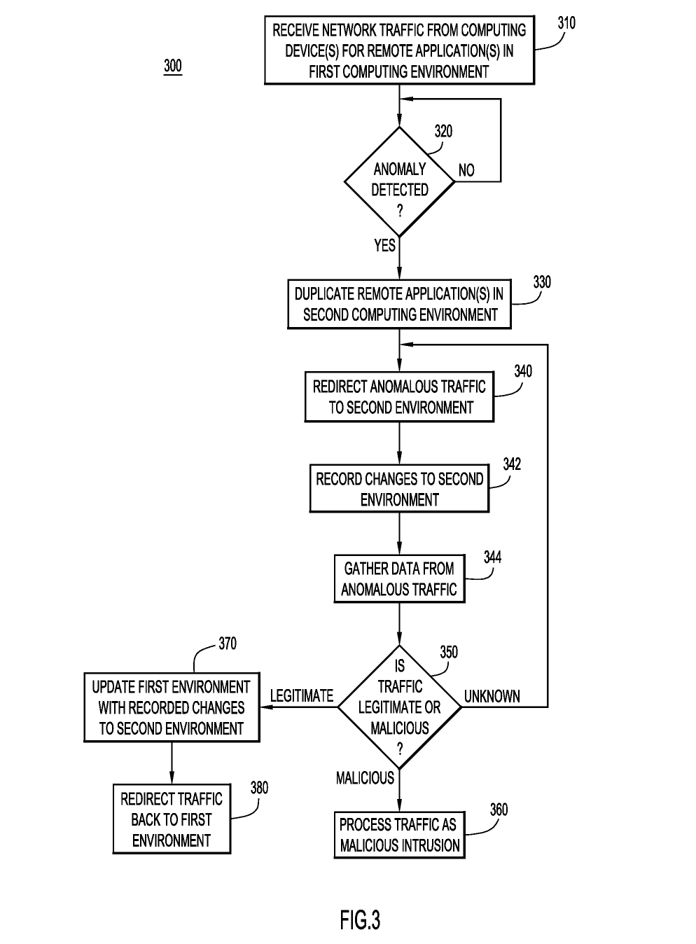

Referring now to FIG. 3, a flow chart is shown of operations performed by a computing device in a process 300 for redirecting anomalous traffic to a second computing environment until sufficient information on the traffic is gathered to determine whether the traffic is malicious or not. In step 310, an application security monitor receives network traffic from one or more computing devices. The network traffic is directed to one or more remote applications in a first computing environment, such as a production environment. When the application security monitor detects an anomaly in the network traffic from one of the computing devices, as determined in step 320, the application security monitor initiates a second computing environment (e.g., a scrubbing environment). In step 330, the one or more remote applications from the first computing environment are substantially duplicated in the second computing environment. In one example, at least one of the remote applications may be exactly duplicated while at least another of the remote applications is reproduced with sanitized data. For instance, a back end database may be reproduced with some falsified database entries to protect the confidentiality of the information in those database entries.

After the second computing environment has substantially reproduced the remote applications from the first computing environment, the application security monitor redirects the anomalous traffic to the second computing environment in step 340. In step 342, a change monitor records any changes to the second computing environment that are caused by the redirected, anomalous traffic. In one example, a database transaction recorder records any requests in the anomalous traffic and the changes that these requests cause in a back end database. In step 344, additional data about the anomalous traffic is gathered as it is redirected to the second computing environment. In one example, the application security monitor gathers the information about the anomalous traffic. Alternatively, a separate application may gather the information and/or analyze the information about the anomalous traffic.

In step 350, the additional data gathered in step 344 is analyzed to determine if the anomalous traffic is malicious or legitimate. If there is still not enough information about the anomalous traffic to determine whether the traffic is malicious or legitimate, the process 300 returns to step 340 in which the application security monitor redirects more anomalous traffic to the second computing environment. If the additional information confirms a determination in step 350 that the anomalous traffic is malicious, then the application security system processes the traffic as a malicious intrusion (e.g., an attack) in step 360. In one example, the malicious traffic may continue to be processed in the second computing environment to study and profile the attack using known techniques. Alternatively, the malicious traffic may simply be dropped.

If the additional information confirms a determination in step 350 that the anomalous traffic is legitimate, then the first computing environment is updated with the recorded changes from the second computing environment in step 370. In one example, the database transaction recorder may replay all of the recorded requests to the back end database in the first computing environment. Once the first computing environment has been updated in step 370, the application security monitor redirects the traffic from the suspected computing device back to the first computing environment in step 380.

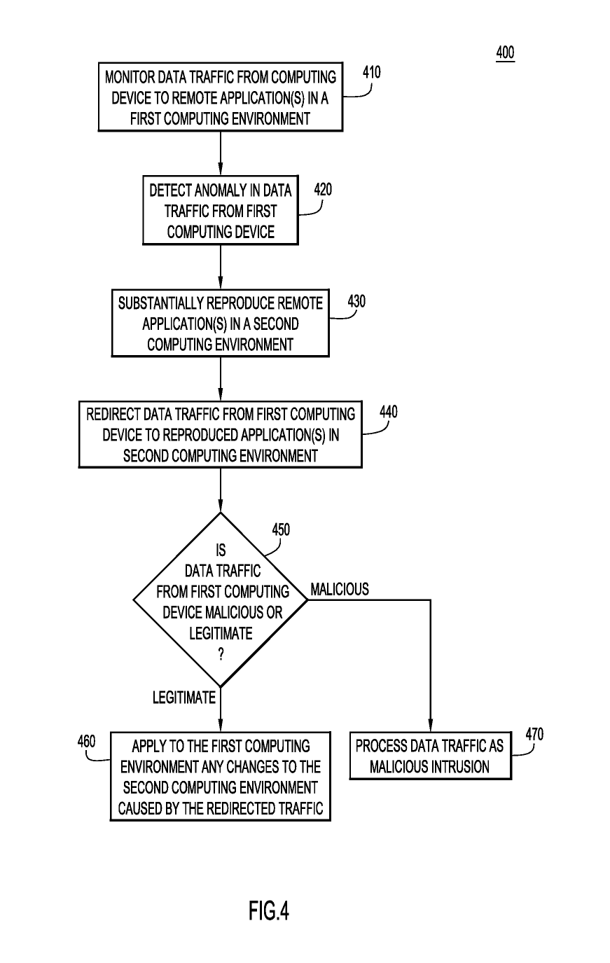

Referring now to FIG. 4, a flow chart is shown of operations performed by a computing device running a process 400 of an application security monitor in redirecting anomalous traffic to a second computing environment and redirecting the traffic back to a first computing environment when the traffic is determined to be legitimate. In step 410, the application security monitor monitors data traffic from a plurality of computing devices to one or more remote applications in a first computing environment. In one example, the one or more remote applications include a front end application, such as an HTTP server application, and a back end application, such as a database server application. In step 420, the application security monitor detects an anomaly in the data traffic from a first computing device among the plurality of computing devices. In one example, the anomaly may include a request to access information that is not authorized for the user of the first computing device. In another example, the anomaly may include login attempts for at least a predetermined number of user accounts over a predetermined amount of time.

In response to detecting the anomaly in step 420, the application security monitor substantially reproduces the one or more remote applications from the first computing environment in a second computing environment in step 430. In one example, the second computing environment may be a scrubbing environment dedicated to the first computing device, which sent the anomalous data traffic. In another example, at least one of the remote applications in the second computing environment may not be exact duplicates of the corresponding remote application in the first computing environment. For instance, the schema of a back end database in the first computing environment may be reproduced in the second computing environment, but at least some of the data within the schema may be altered to protect confidential information.

Once the remote applications from the first computing environment are substantially reproduced in the second computing environment, the application security monitor redirects the data traffic from the first computing device to the reproduced one or more remote applications in the second computing environment in step 440. If the data traffic from the first computing device is determined to be legitimate in step 450, then any changes to the second computing environment caused by the redirected traffic are applied to the first computing environment in step 460. In one example, a database transaction recorder in the second computing environment replays all of the requests from the redirected traffic to apply the changes to a back end database in the first computing environment.

If the data traffic from the first computing device is determined to be malicious in step 450, then the data traffic is processed as malicious traffic in step 470. In one example, the confirmed malicious traffic continues to be processed in the second computing environment to further analyze and profile the origin and/or signature of the malicious traffic. Alternatively, the malicious traffic may simply be dropped.

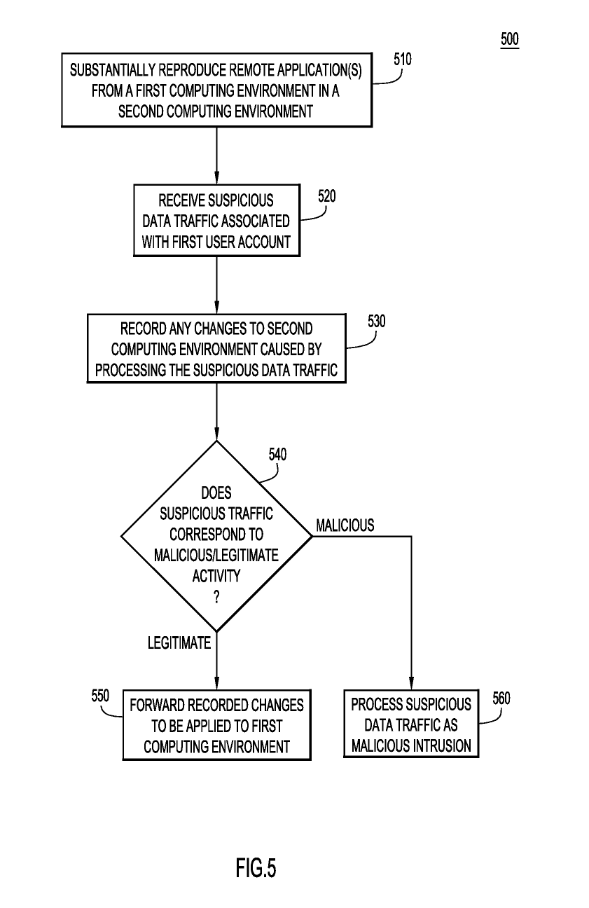

Referring now to FIG. 5, a flow chart is shown that illustrates operations performed by an isolated computing environment in a process 500 for processing suspicious traffic while an analysis of the suspicious traffic is conducted. In step 510, a second computing environment substantially reproduces one or more remote applications from a first computing environment. In one example, the reproduced one or more remote applications may include a reproduced front end application that is exactly reproduced (i.e., same version, same code, etc.) from the first computing environment and a reproduced back end application that is reproduced with altered data. For instance, the reproduced back end application may be a database that reproduces the schema of the original back end database from the first computing environment, but with some of the values of the database entries modified to protect confidential information from being exposed. In other examples, the reproduced front end application may also be altered from the version in the first computing environment. For instance, a different version or type of web server may instantiated in the second computing environment as the front end application.

In step 520, the second computing environment receives suspicious data traffic associated with a first user account. In one example, the second computing environment process the suspicious data traffic with the remote applications reproduced in step 510. In step 530, the second computing environment records any changes to the second computing environment caused by processing the suspicious data traffic. In one example, a database transaction recorder generates a transaction log of one or more requests from the suspicious traffic as those requests are processed into a reproduced back end database application.

In step 540, the suspicious traffic is analyzed to determine whether the suspicious traffic corresponds to malicious activity or legitimate activity. If the suspicious traffic corresponds to legitimate activity, then the second computing environment forwards the recorded changes to be applied to the first computing environment in step 550. In one example, the transaction log from the database transaction recorder is sent to the first computing environment enabling the first computing environment to be updated. If the suspicious traffic is determined to correspond to malicious activity in step 540, then the second computing environment processes the suspicious data traffic as a malicious intrusion in step 560. In one example, the malicious intrusion may be allowed to proceed in the second computing environment, which is isolated from any sensitive information in the first computing environment. Alternatively, the second computing environment may simply drop the suspicious traffic and delete the reproduced remote applications.

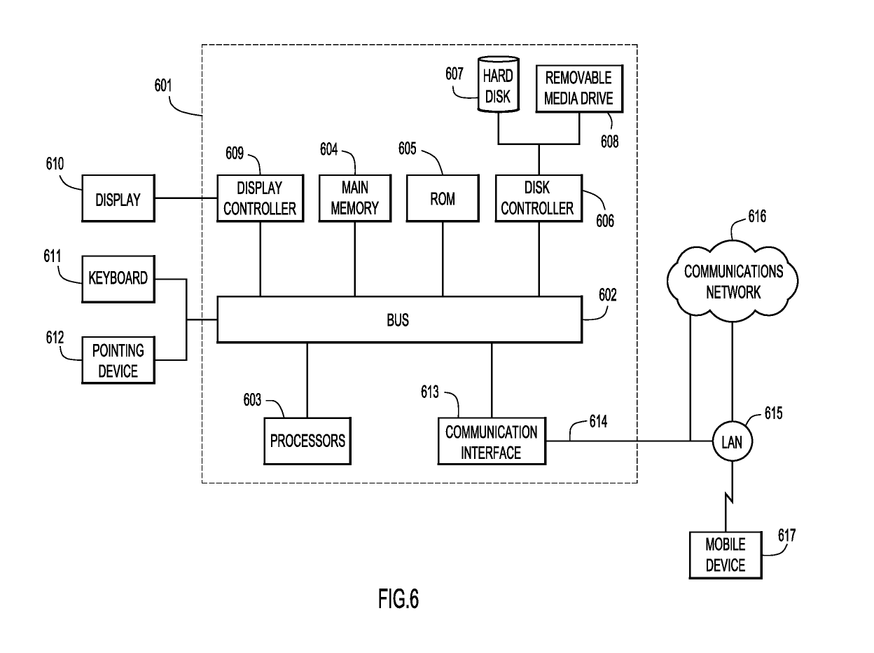

Referring now to FIG. 6, an example of a block diagram of a computer system 601 that may be representative of a computing device in which the embodiments presented may be implemented is shown. The computer system 601 may be programmed to implement a computer based device, such as a device implementing the first computing environment 120 and/or the second computing environment 230. The computer system 601 includes a bus 602 or other communication mechanism for communicating information, and a processor 603 coupled with the bus 602 for processing the information. While the figure shows a single block 603 for a processor, it should be understood that the processors 603 may represent a plurality of processing cores, each of which can perform separate processing. The computer system 601 also includes a main memory 604, such as a random access memory (RAM) or other dynamic storage device (e.g., dynamic RAM (DRAM), static RAM (SRAM), and synchronous DRAM (SD RAM)), coupled to the bus 602 for storing information and instructions to be executed by processor 603. In addition, the main memory 604 may be used for storing temporary variables or other intermediate information during the execution of instructions by the processor 603.

The computer system 601 further includes a read only memory (ROM) 605 or other static storage device (e.g., programmable ROM (PROM), erasable PROM (EPROM), and electrically erasable PROM (EEPROM)) coupled to the bus 602 for storing static information and instructions for the processor 603.

The computer system 601 also includes a disk controller 606 coupled to the bus 602 to control one or more storage devices for storing information and instructions, such as a magnetic hard disk 607, and a removable media drive 608 (e.g., floppy disk drive, read-only compact disc drive, read/write compact disc drive, compact disc jukebox, tape drive, and removable magneto-optical drive, solid state drive, etc.). The storage devices may be added to the computer system 601 using an appropriate device interface (e.g., small computer system interface (SCSI), integrated device electronics (IDE), enhanced-IDE (E-IDE), direct memory access (DMA), ultra-DMA, or universal serial bus (USB)).

The computer system 601 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, include types of processing circuitry. The processing circuitry may be located in one device or distributed across multiple devices.

The computer system 601 may also include a display controller 609 coupled to the bus 602 to control a display 610, such as a cathode ray tube (CRT), liquid crystal display (LCD) or light emitting diode (LED) display, for displaying information to a computer user. The computer system 601 includes input devices, such as a keyboard 611 and a pointing device 612, for interacting with a computer user and providing information to the processor 603. The pointing device 612, for example, may be a mouse, a trackball, track pad, touch screen, or a pointing stick for communicating direction information and command selections to the processor 603 and for controlling cursor movement on the display 610. In addition, a printer may provide printed listings of data stored and/or generated by the computer system 601.

The computer system 601 performs a portion or all of the processing steps of the operations presented herein in response to the processor 603 executing one or more sequences of one or more instructions contained in a memory, such as the main memory 604. Such instructions may be read into the main memory 604 from another computer readable storage medium, such as a hard disk 607 or a removable media drive 608. One or more processors in a multi-processing arrangement may also be employed to execute the sequences of instructions contained in main memory 604. In alternative embodiments, hard-wired circuitry may be used in place of or in combination with software instructions. Thus, embodiments are not limited to any specific combination of hardware circuitry and software.

As stated above, the computer system 601 includes at least one computer readable storage medium or memory for holding instructions programmed according to the embodiments presented, for containing data structures, tables, records, or other data described herein. Examples of computer readable storage media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM, DVD), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 601, for driving a device or devices for implementing the operations presented herein, and for enabling the computer system 601 to interact with a human user (e.g., a network administrator). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 601 also includes a communication interface 613 coupled to the bus 602. The communication interface 613 provides a two-way data communication coupling to a network link 614 that is connected to, for example, a local area network (LAN) 615, or to another communications network 616 such as the Internet. For example, the communication interface 613 may be a wired or wireless network interface card to attach to any packet switched (wired or wireless) LAN. As another example, the communication interface 613 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 613 sends and receives electrical, electromagnetic or optical signals that carry digital data streams representing various types of information.

The network link 614 typically provides data communication through one or more networks to other data devices. For example, the network link 614 may provide a connection to another computer through a local area network 615 (e.g., a LAN) or through equipment operated by a service provider, which provides communication services through a communications network 616. The local network 614 and the communications network 616 use, for example, electrical, electromagnetic, or optical signals that carry digital data streams, and the associated physical layer (e.g., CAT 5 cable, coaxial cable, optical fiber, etc.). The signals through the various networks and the signals on the network link 614 and through the communication interface 613, which carry the digital data to and from the computer system 601 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 601 can transmit and receive data, including program code, through the network(s) 615 and 616, the network link 614 and the communication interface 613. Moreover, the network link 614 may provide a connection through a LAN 615 to a mobile device 617 such as a personal digital assistant (PDA), tablet computer, laptop computer, or cellular telephone.

In summary, the techniques presented herein provide for using an application security monitor to inspect a user's application traffic, and, when the traffic is deemed suspicious, deploying an isolated scrubbing environment into which a suspicious user's traffic may be dynamically redirected. The suspicious user's traffic may be further scrutinized while it is being processed in the scrubbing environment without risk to legitimate users. Additionally, any changes to the scrubbing environment may be recorded to replay the user's session back in to the original environment once the suspicious traffic is deemed to the safe.

Initial indicators of anomalous traffic to a production environment provide a low threshold for spawning a scrubbing environment. The scrubbing environment continues to process the anomalous traffic, which may be tagged as a false positive (i.e., it is tagged as suspicious, but is not malicious), to gather additional indicators of the user intent behind the suspicious traffic. Seamlessly re-integrating any false positive traffic back into the production environment enables a low threshold for redirecting traffic to a scrubbing environment, since the low threshold inevitably leads to a significant number of false positive results, which should not be dropped as malicious. Populating the scrubbing environment with remote application containers cloned from a container repository enables the application security system to quickly react at the first potential sign of an attack.

The application security system described herein leverages a cloned production service chain that lacks sensitive data, which provides several advantages over traditional network and application security models. Legitimate transactions that might have otherwise been flagged as a false positive (e.g., by a static security policy) may still be processed. A malicious user who manages to break out of, or otherwise exploit, an application sandbox is still isolated to the safe, containerized, quarantined host. Since all of the malicious traffic is redirected to the scrubbing environment where it is terminated, there is no way for the malicious user to access any production data, even if they gain full control inside the container.

By continuing to process an attacker's transactions in isolation, the application security system avoids tipping the attacker to the presence of the application security system. The attacker may be distracted in an easily monitored and contained environment without risk to the production infrastructure. Additionally, the scrubbing environment may modify its runtime characteristics to slow down (i.e., tar pit) the attacker. For instance, the scrubbing environment may be run with one tenth the normal processing speed to slow down an attack, allowing advanced forensics systems to be engaged (e.g., to trace the source of the attack). Further, the production endpoints running the remote application(s) do not need to waste resources processing traffic from illegitimate sources, since any suspicious traffic is redirected away from the production service chain/nodes and into the scrubbing environment.

In one form, a method is provided for an application security monitor to direct anomalous data from a first computing environment to a second computing environment until it is determined to be legitimate in the first computing environment. The method includes monitoring data traffic from a plurality of computing devices to at least one remote application in the first computing environment. An anomaly is detected in the data traffic from a first computing device among the plurality of computing devices. Based on the detected anomaly, the at least one remote application is substantially reproduced in the second computing environment. The data traffic from the first computing device is redirected to the at least one remote application in the second computing environment. The method further includes determining whether the data traffic from the first computing device corresponds to malicious activity or legitimate activity by the first computing device. Responsive to a determination that the data traffic from the first computing device corresponds to legitimate activity, the method includes applying to the first computing environment any changes in the second computing environment caused by the redirected traffic from the first computing device.

In another form, an apparatus is provided comprising a network interface unit and a processor coupled to the network interface unit. The network interface unit is configured to receive data traffic from a plurality of computing devices. The processor is configured to monitor the data traffic from the plurality of computing devices to at least one remote application in a first computing environment. The processor is also configured to detect an anomaly in the data traffic from a first computing device among the plurality of computing devices. Based on the detected anomaly, the processor is configured to substantially reproduce the at least one remote application in a second computing environment. The processor is further configured to redirect the data traffic from the first computing device to the at least one remote application in the second computing environment. The processor is configured to determine whether the data traffic from the first computing device corresponds to malicious activity or legitimate activity by the first computing device. Responsive to a determination that the data traffic from the first computing device corresponds to legitimate activity, the processor is configured to apply to the first computing environment any changes in the second computing environment caused by the redirected data traffic from the first computing device.

In a further form, a non-transitory computer readable storage media is provided that is encoded with instructions that, when executed by a processor, cause the processor to monitor data traffic from a plurality of computing devices to at least one remote application in a first computing environment. The instructions cause the processor to detect an anomaly in the data traffic from a first computing device among the plurality of devices. Based on the detected anomaly, the instructions cause the processor to substantially reproduce the at least one remote application in a second computing environment. The instructions also cause the processor to redirect the data traffic from the first computing device to the at least one remote application in the second computing environment. The instructions further cause the processor to determine whether the data traffic from the first computing device corresponds to malicious activity or legitimate activity by the first computing device. Responsive to a determination that the data traffic from the first computing device corresponds to legitimate activity, the instructions cause the processor to apply to the first computing environment any changes in the second computing environment caused by the redirected traffic from the first computing device.

In still another form, a method is provided for a second computing environment to process suspicious traffic and update a first computing environment after the suspicious data traffic is determined to be legitimate. The method includes substantially reproducing at least one remote application from the first computing environment in the second computing environment. The second computing environment receives the suspicious data traffic associated with a first user account. The suspicious data traffic is redirected from the first computing environment. The second computing environment records any changes to the second computing environment caused by processing the suspicious data traffic. Responsive to a determination that the suspicious data traffic corresponds to legitimate activity, the second computing environment forwards the recorded changes to be applied in the first computing environment.

In yet another form, an apparatus is provided comprising a network interface unit and a processor coupled to the network interface unit. The network interface unit is configured to enable network connectivity. The processor is configured to: substantially reproduce at least one remote application from a first computing environment in a second computing environment; receive suspicious data traffic associated with a first user account, the suspicious data traffic being redirected from the first computing environment; record any changes to the second computing environment caused by processing the suspicious data traffic; and responsive to a determination that the suspicious data traffic corresponds to legitimate activity, forward the recorded changes to be applied in the first computing environment.

In still another form, a non-transitory computer readable storage media is provided that is encoded with instructions that, when executed by a processor, cause the processor to: substantially reproduce at least one remote application from a first computing environment in a second computing environment; receive suspicious data traffic associated with a first user account, the suspicious data traffic being redirected from the first computing environment; record any changes to the second computing environment caused by processing the suspicious data traffic; and responsive to a determination that the suspicious data traffic corresponds to legitimate activity, forward the recorded changes to be applied in the first computing environment.

The above description is intended by way of example only. The present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Although the techniques are illustrated and described herein as embodied in one or more specific examples, it is nevertheless not intended to be limited to the details shown, since various modifications and structural changes may be made within the scope and range of equivalents of this disclosure.

What is claimed is:

1. A method comprising:
monitoring data traffic from a plurality of computing devices to at least one remote application in a first computing environment;
detecting an anomaly in the data traffic from a first computing device among the plurality of computing devices;
based on the detected anomaly, substantially reproducing the at least one remote application in a second computing environment;
redirecting the data traffic from the first computing device to the at least one remote application in the second computing environment;
determining whether the data traffic from the first computing device corresponds to malicious activity or legitimate activity by the first computing device; and
responsive to a determination that the data traffic from the first computing device corresponds to legitimate activity, applying to the first computing environment any changes in the second computing environment caused by the redirected data traffic from the first computing device.

2. The method of claim 1, wherein determining whether the data traffic from the first computing device corresponds to malicious activity or legitimate activity comprises monitoring the redirected data traffic.

3. The method of claim 1, wherein the at least one remote application in the first computing environment includes a first database accessed by the plurality of computing devices, and wherein the at least one remote application in the second computing environment includes a second database accessed by the first computing device.

4. The method of claim 3, wherein applying to the first computing environment the changes to the second computing environment comprises:
recording changes in the second database; and
applying the changes in the second database to the first database.

5. The method of claim 4, wherein recording the changes in the second database comprises storing a transaction log of the changes in the second database.

6. The method of claim 3, further comprising sanitizing data in the second database for at least one of the plurality of computing devices.

7. The method of claim 1, wherein the at least one remote application is substantially reproduced in the second computing environment before determining whether the data traffic from the first computing device corresponds to malicious activity or legitimate activity.

8. The method of claim 1, wherein the second computing environment runs with less computing resources than the first computing environment.

9. An apparatus comprising:
a network interface unit configured to receive data traffic from a plurality of computing devices; and
a processor coupled to the network interface unit and configured to:
monitor the data traffic from the plurality of computing devices to at least one remote application in a first computing environment;
detect an anomaly in the data traffic from a first computing device among the plurality of computing devices;
based on the detected anomaly, substantially reproduce the at least one remote application in a second computing environment;
redirect the data traffic from the first computing device to the at least one remote application in the second computing environment;
determine whether the data traffic from the first computing device corresponds to malicious activity or legitimate activity by the first computing device; and
responsive to a determination that the data traffic from the first computing device corresponds to legitimate activity, apply to the first computing environment any changes in the second computing environment caused by the redirected data traffic from the first computing device.

10. The apparatus of claim 9, wherein the processor is configured to determine whether the data traffic from the first computing device corresponds to malicious activity or legitimate activity by monitoring the redirected data traffic.

11. The apparatus of claim 9, wherein the at least one remote application in the first computing environment includes a first database accessed by the plurality of computing devices, and wherein the at least one remote application in the second computing environment includes a second database accessed by the first computing device.

12. The apparatus of claim 11, wherein the processor is configured to apply to the first computing environment the changes to the second computing environment by:
recording changes in the second database; and
applying the changes in the second database to the first database.

13. The apparatus of claim 11, wherein the processor is configured to sanitize data in the second database data for at least one of the plurality of computing devices.

14. The apparatus of claim 9, wherein the processor is configured to substantially reproduce the at least one remote application in the second computing environment before determining whether the data traffic from the first computing device corresponds to malicious activity or legitimate activity.

15. The apparatus of claim 9, wherein the processor is configured to provide the second computing environment with less computing resources than the first computing environment.

16. A method comprising:
substantially reproducing at least one remote application from a first computing environment in a second computing environment;
receiving suspicious data traffic associated with a first user account, the suspicious data traffic being redirected from the first computing environment;
recording any changes to the second computing environment caused by processing the suspicious data traffic; and
responsive to a determination that the suspicious data traffic corresponds to legitimate activity, forwarding the recorded changes to be applied in the first computing environment.

17. The method of claim 16, wherein the at least one remote application in the first computing environment includes a first database accessed by a plurality of user accounts, and wherein the at least one remote application in the second computing environment includes a second database accessed by the first user account.

18. The method of claim 17, further comprising storing a transaction log of changes to the second database caused by the suspicious data traffic.

19. The method of claim 17, further comprising sanitizing data in the second database for at least one of the plurality of user accounts.

20. The method of claim 16, wherein the second computing environment runs with less computing resources than the first computing environment.
